(19) United States
(12) Patent Application Publication
(10) Pub. No.: US 2014/0026974 A1
(43) Pub. Date: Jan. 30, 2014

(54) PROCESS OF MANUFACTURING A TURBOJET ENGINE NACELLE PART

(71) Applicant: AIRCELLE, Gonfreville L'Orcher (FR)

(72) Inventors: Bertrand DESJOYEAUX, Sainte Adresse (FR); Olivier Hubier, Le Havre (FR)

(73) Assignee: AIRCELLE, Gonfreville L'Orcher (FR)

(21) Appl. No.: 13/953,368

(22) Filed: Jul. 29, 2013

Related U.S. Application Data
(63) Continuation of application No. PCT/FR2012/050126, filed on Jan. 20, 2012.

(30) Foreign Application Priority Data
Jan. 28, 2011 (FR) 11/50654

(51) Int. Cl. B29D 99/00; F02C 7/04

(52) U.S. Cl. CPC B29D 99/001; F02C 7/04
USPC 137/15.1; 264/258

(57) ABSTRACT

A method for manufacturing a nacelle air intake lip including a plurality of components includes the following steps. The first step is positioning, inside a mold, two components within a set of fibrous layers encompassing all or part of the components so that a preform is formed. Next step is performing impregnation of the obtained preform to obtain molding of the nacelle air intake lip.

### CROSS-REFERENCE TO RELATED APPLICATIONS

This application is a continuation of International Application No. PCT/FR2012/050126, filed on Jan. 20, 2012, which claims the benefit of FR 11/50654, filed on Jan. 28, 2011. The disclosures of the above applications are incorporated herein by reference.

### FIELD

The present disclosure relates to a method for manufacturing a turbojet engine nacelle part and a turbojet engine nacelle air intake lip manufactured according to the method.

### BACKGROUND

The statements in this section merely provide background information related to the present disclosure and may not constitute prior art.

As is known in itself, an aircraft propulsion assembly traditionally comprises a turbojet engine housed inside a nacelle.

The nacelle generally has an annular structure comprising an air intake upstream from the turbojet engine, a middle section designed to surround a fan of the turbojet engine and its casing, and a downstream section designed to surround the combustion chamber of the turbojet engine and housing thrust reverser means if applicable. It may end with a jet nozzle whereof the outlet is situated downstream from the turbojet engine.

The air intake structure serves to optimize the capture of air necessary to supply the fan of the turbojet engine and channel it toward said fan.

An air intake structure in particular comprises an upstream leading edge structure commonly called the air intake “lip.”

The air intake lip ensures the capture of the air and is attached to the rest of the air intake structure, which ensures channeling of the captured air toward the turbojet engine.

To that end, the rest of the air intake structure has a substantially annular structure comprising an outer surface ensuring the outer aerodynamic continuity of the nacelle and an inner surface ensuring the inner aerodynamic continuity of the nacelle. The air intake lip ensures the upstream connection between those two surfaces.

The assembly of the air intake structure is attached upstream to a middle section of the nacelle and a fan casing.

An air intake lip structure may comprise many components. Traditionally, it in particular includes a reinforcing partition, an aerodynamic skin that may be made in several sectors clipped to each other, one or more junction profiles for the partitions or for attachment to the rest of the air intake structure.

Currently, these elements may be made from heterogeneous materials, and in particular from different metal alloys, typically with a base of aluminum and/or titanium. Certain elements may also be made from composite materials.

Today, these elements must be assembled by fastening. This results in a significant assembly time and a loss of aerodynamic performance related to said fastenings and assemblies. Furthermore, the fastening points create fragile areas in the structure.

### SUMMARY

The present disclosure provides a method for manufacturing a nacelle part comprising a plurality of component elements, comprising the following steps:
positioning, inside a mold, at least two component elements within a set of fibrous layers encompassing all or part of the component elements and thereby forming a preform; and
performing impregnation of the obtained preform to obtain molding of the part.

It is in particular possible to use an LCM (liquid composite molding).

Thus, by integrating, into a single molding operation, the air intake lip structural skin, any inner stiffening structures, the flange(s) or protuberances on the inner face for connection and integration with the other components of the nacelle and/or the engine in the immediate vicinity, it is possible to obtain a self-stiffened single piece, connecting all of the component elements to each other without needing to use additional fastening means, clips, or other means.

The mass of the part is therefore not affected by adding fasteners. The assembly time is also greatly reduced. Furthermore, the inner structures molded with the outer wall may enables the assembly, with the rest of the structure, to the rear part of the lip, with no alterations of the aerodynamic surface.

According to a first alternative form, the addition of resin is done using a resin infusion-type method.

According to a second alternative form, the addition of resin is done using a resin injection method, in particular a resin transfer molding (RTM) method.

In one form, part of the covering layers is designed to form an outer skin and/or inner skin of the part.

Advantageously, the layers completely cover the assembly.

Advantageously, these layers are made up of fabrics or plaits woven in a form so as to be able to adapt to a desired geometric shape.

Advantageously, these layers may be connected to each other by sewing or another technique for adding threads connecting the layers to each other so as to reinforce the texture.

According to still another form, at least one element is an inner stiffener, in particular radial. The stiffening elements may for example be metal made from stacked fibrous layers.

Advantageously, the stiffening element(s) are made up of layers of fabrics or plaits, with parts folded down across from the outer or inner wall of the part.

Advantageously, the parts of the stiffener connected with the wall are reinforced by sewing or any other technique for adding threads connecting the layers to each other so as to reinforce the connection or assist with the assembly operation for molding.

According to still another form, the part comprises at least one interfacing and connecting means designed to allow connection with another part of the nacelle. Advantageously, this interface is made up of an inner surface of the aerodynamic wall, which is capable of gluing. In one alternative form, the attachment is completed by a surface separate from the outer wall, such as an inner structure previously described, with which the attachment can be done using fasteners.

In still another form, an inner structure is made up of a circumferential radial partition, joining a rear area of the inner surface of the lip with a rear area of the outer surface of the lip, so as to impart great stiffness to the assembly.

In one alternative form, the partition is worked with openings or hatches, allowing access to the front area.

According to one aspect of the present disclosure, at least one element is a core with a cellular structure and the cellular core is covered with at least one sealing film, said element being able to be inserted between layers making up at least one of the faces or partitions.

According to another aspect, at least one element is a core made from a light filler material of the foam or closed cellular core type.

The present disclosure also relates to a turbojet engine nacelle part that can be obtained using a method according to the present disclosure. For example, the part is an air intake lip.

Further areas of applicability will become apparent from the description provided herein. It should be understood that the description and specific examples are intended for purposes of illustration only and are not intended to limit the scope of the present disclosure.

### DRAWINGS

In order that the present disclosure may be well understood, there will now be described various forms thereof, given by way of example, reference being made to the accompanying drawings, in which:

FIG. 1 is a general diagrammatic illustration of a turbojet engine nacelle comprising an air intake lip;

FIG. 2 is a view of an air intake lip structure obtained using a method according to the present disclosure;

FIG. 3 is a transverse cross-sectional view of the air intake lip according to FIG. 2;

FIGS. 4 and 5 are diagrammatic transverse cross-sectional views of alternative forms of an air intake lip using a method according to the present disclosure; and

FIG. 6 is a diagrammatic transverse cross-sectional illustration of a mold for manufacturing the lip of FIGS. 2 and 3.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

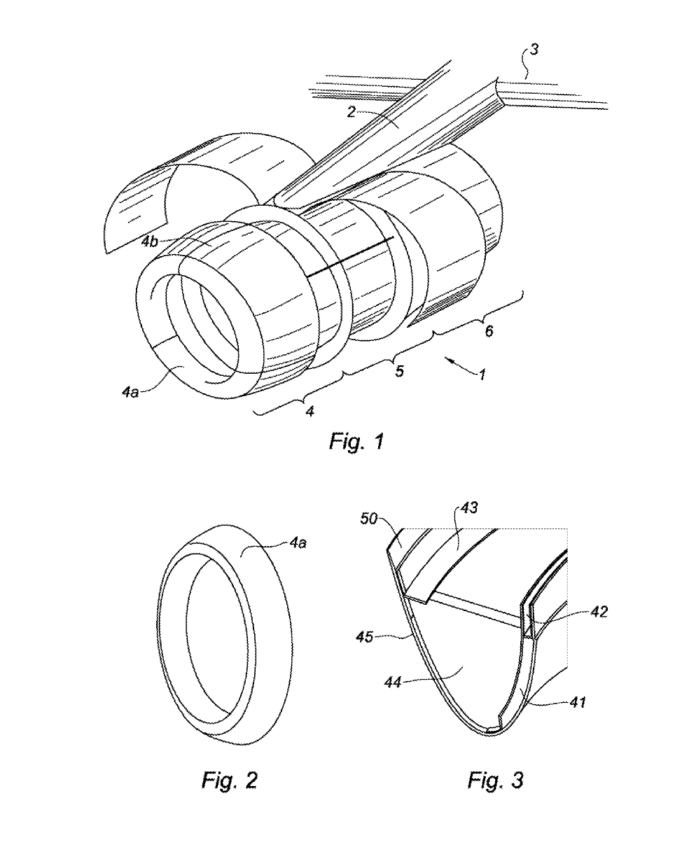

FIG. 1 shows a turbojet engine nacelle 1 attached to a pylon 2 of a wing 3 of an aircraft.

Typically, this nacelle 1 constitutes a substantially tubular housing for the turbojet engine and comprises an upstream air intake structure 4, a middle section 5 surrounding a fan (not shown) of the turbojet engine, and a downstream section 6 ensuring the discharge of the flow of air and, if applicable, equipped with thrust reverser means.

As shown in FIG. 1, the air intake structure 4 comprises an air intake lip structure 4a capturing air and is attached to the rest 4b of the air intake structure 4 that ensures channeling of the captured air toward the turbojet engine.

The air intake lip 4a alone is shown in FIG. 2. It has a single-piece structure obtained using the method according to the present disclosure.

A cross-sectional view in FIG. 3 shows the inner structure of said air intake lip 4a.

According to the present disclosure, the air intake structure 4a comprises a plurality of component elements, i.e., in particular a honeycomb acoustic attenuation structure 41, a profile 42, for example in the shape of a C or T, designed to allow the downstream junction with the rest 4b of the air intake structure 4, a T-shaped profile 43 to provide the junction with a peripheral inner partition, longitudinal reinforcing ribs 44. All of the component elements are covered with an aerodynamic outer skin 45. Of course, these elements are provided as an example and the air intake lip 4a may comprise others, or elements with different shapes.

Part of said fibrous layers will, after resin injection and polymerization, make up the outer aerodynamic skin 45. Another part of the layers will make up an inner skin if needed.

In the method according to the present disclosure, the component elements 41, 42, 43, 44 are positioned above or between component fibrous layers 45.

Thus positioned inside a mold 60 (FIG. 6), a resin injection is done using an RTM (resin transfer molding 60), resin infusion, or other method.

It should be noted that in order to preserve the integrity of the honeycomb acoustic structure of 41, a sealing film may be placed before injection of the resin and subsequently removed. Thus, the cavities of the acoustic attenuation structure will not be blocked by the resin.

It is also possible to provide that one end 50 of the layers of the air intake structure is designed for assembly by gluing with the rear structure 4b and prepared to that end using a method known in itself.

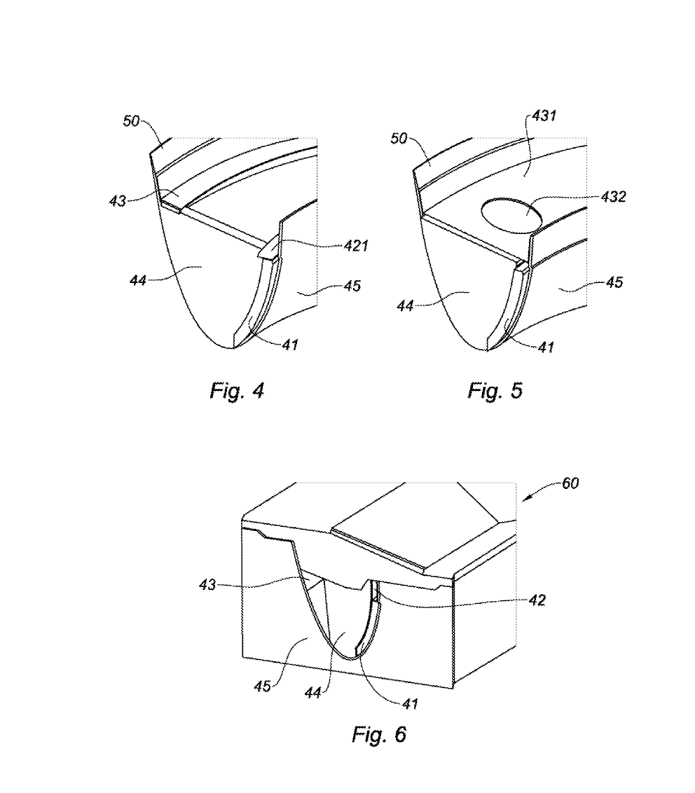

FIGS. 4 and 5 show alternative forms of an air intake lip using a method according to the present disclosure.

The lip of FIG. 4 in particular has an L-shaped junction flange 421 for the downstream junction.

The lip of FIG. 5 in particular has a partition 431 that is integrated and equipped with hatches 432 to allow access to the inside space of the lip (placement of deicing equipment, for example).

Although the present disclosure has been described with one particular example form, it is of course in no way limited thereto and encompasses all technical equivalents of the described means as well as combinations thereof if they are within the scope of the present disclosure.

What is claimed is:

1. A method for manufacturing a nacelle air intake lip comprising a plurality of component elements, the method comprising:
positioning, inside a mold, at least two component elements within a set of fibrous layers encompassing all or part of the component elements and thereby forming a preform; and
performing impregnation of the obtained preform to obtain molding of the nacelle air intake lip.

2. The method according to claim 1, wherein the performing impregnation is done using a resin infusion-type method.

3. The method according to claim 1, wherein the performing impregnation is done using a resin transfer molding (RTM) method.

4. The method according to claim 1, wherein at least part of the preform comprises fibrous layers made from carbon fibers, forming at least one of an outer and inner skin of the nacelle air intake lip.

5. The method according to claim 1, wherein the layers are made up of fabrics or plaits woven in a form to adapt to a desired geometric shape.

6. The method according to claim 1, wherein at least one layer is a cellular structure core covered by at least one sealing film.

7. The method according to claim 1, wherein at least one element is a core made from a light filler material of foam or closed cellular core type.

8. The method according to claim 1, wherein at least one element is an inner stiffener.

9. The method according to claim 8, wherein the inner stiffener is radial.

10. The method according to claim 1, wherein the nacelle air intake lip further comprises an inner structure forming a stiffener made up of a circumferential radial partition, joining a rear area of the inner surface of the lip to a rear area of the outer surface of the lip.

11. The method according to claim 8, wherein at least one stiffener is made from a fibrous structure.

12. The method according to claim 11, wherein the at least one stiffener is made with a base of carbon fibers.

13. The method according to claim 1, wherein it comprises at least one interfacing and connecting means designed to allow connection with another part of the nacelle.

14. A turbojet engine nacelle air intake lip manufactured using the method according to claim 1.
